(19) United States
(12) Patent Application Publication
(10) Pub. No.: US 2023/0192451 A1
(43) Pub. Date: Jun. 22, 2023

(54) LIFTING CLAMP

(71) Applicants: ING CO., LTD., Osaka (JP); NAGAKI SEIKI CO., LTD., Osaka (JP)

(72) Inventors: Masao SHIOMI, Osaka (JP); Junsuke TAKADA, Osaka (JP); Akiko TSUCHIYA, Osaka (JP)

(73) Assignees: ING CO., LTD., Osaka (JP); NAGAKI SEIKI CO., LTD., Osaka (JP)

(21) Appl. No.: 17/928,068

(22) PCT Filed: Jun. 3, 2021
(86) PCT No.: PCT/JP2021/021248

§ 371 Date: Nov. 28, 2022

(30) Foreign Application Priority Data
Jun. 4, 2020 (JP) 2020-097675
Jun. 3, 2021 (JP) 2021-093368

(51) Int. Cl. B66C 1/42; E04G 21/14

(52) U.S. Cl. CPC B66C 1/42; E04G 21/142

(57) ABSTRACT

In a lifting clamp, a pair of opposite pieces are provided to a main body, wherein the opposite pieces are opposed to form a gripping space where an object to be transported can be gripped. Contact units to contact the object to be transported are provided on the respective gripping space sides of the opposite pieces. A handle is attached to the main body to be rotatable relative to a spindle that is disposed along a gripping direction shown by a dot-dashed line. A conversion unit that converts a rotational movement by turning of the handle into gripping movement to push the contact unit to the gripping side is disposed between the contact unitand the opposite piece. The contact unitis attached to a spindle that supports the handleon one side, and the size of the gripping space can be changed by sliding the spindle with respect to the opposite piece.

### TECHNICAL FIELD

The present invention relates to a lifting clamp for gripping an object to be transported, such as a plate-like material to be slung up and transported, at construction sites and the like.

### BACKGROUND ART

Cranes are used in transporting large-sized panel members at construction sites and the like. To sling up and transport an object to be transported using a crane, the object to be transported needs to be bound by a rope or otherwise secured. In view of this, clamps having a structure that can grip an object to be transported and is able to be hanged with a rope have heretofore been used.

FIG. 16 is a diagram showing a conventional panel clamp 200. A hanging portion 202 that can be hanged with a rope or otherwise secured is disposed at the top of a main body 201 of the panel clamp 200. A receptor arm 203 and a fastening arm 204 are disposed opposite each other at a lower part of the main body 201. A ratchet wrench 205 including a reversible ratchet mechanism for fastening the panel is attached to the fastening arm 204. With such a configuration, an upper end of the panel can be fastened between the fastening arm 204 and the receptor arm 203 by operating the ratchet wrench 205, and the panel can be slung up. Such a panel clamp 200 is disclosed in Patent Literature 1.

### CITATION LIST

### Patent Literature

Patent Literature 1: Japanese Utility Model Application Laid-Open No. Sho. 59-170581 (whole document)

### SUMMARY OF INVENTION

### Technical Problem

However, fastening operation must be performed for each object to be transported, and the operation is troublesome. Moreover, provision of complex mechanisms such as the reversible ratchet mechanism for fastening increases weight and cost. In an event of a failure, a cause of failure is difficult to identify due to its complexity.

In view of the foregoing problems, an object of the present invention is to provide a lifting clamp that has a simple configuration and is capable of automatically fastening at the same time as lifting an object to be transported.

### Solution to Problem

To achieve the foregoing object, a lifting clamp according to the present invention is a lifting clamp for gripping and lifting an object to be transported, the lifting clamp including: a main body that includes a pair of opposite pieces opposed to form a gripping space where a portion to be gripped of the object to be transported can be accommodated; a spindle that is attached to at least either one of the opposite pieces rotatably about a gripping direction and supports a lifting handle outside the main body; a contact unit that is supported by the spindle on a gripping space side and makes contact with the object to be transported in a gripping state; and a conversion unit that is disposed around the spindle and converts a rotational force of the spindle into a pressing force of the contact unit onto the object to be transported.

In the foregoing configuration, the lifting clamp according to the present invention is configured so that the conversion unit includes: an end cam that is formed to surround the spindle and fixed to the opposite piece; and a follower that is integrally rotatable with the spindle and slides over the end cam to cause a movement in the gripping direction.

In the foregoing configuration, the lifting clamp according to the present invention is configured so that the conversion unit includes: a cylindrical cam that is formed to surround the spindle and fixed to the opposite piece; and a follower that is integrally rotatable with the spindle and slides over the cylindrical cam to cause a movement in the gripping direction.

In the foregoing configuration, the lifting clamp according to the present invention is configured so that at least either one of the opposite pieces is equipped with an adjustment unit that adjusts a distance to the contact unit.

In the foregoing configuration, the lifting clamp according to the present invention is configured so that the handle has at least one depressed portion outward in a radial direction of turning.

In the foregoing configuration, the lifting clamp according to the present invention includes a one-way clutch that includes an inner ring integrally movably attached to the spindle and an outer ring attached to the main body in a selectively fixable and releasable manner, and allows rotation of the spindle only in a direction of increasing the pressing force.

In the foregoing configuration, the lifting clamp according to the present invention includes an outer ring fixing unit that is provided between the outer ring and the main body and capable of fixing and releasing the outer ring to/from the main body.

In the foregoing configuration, the lifting clamp according to the present invention is configured so that the spindle is fitted to the inner ring by transition fit.

In the foregoing configuration, the lifting clamp according to the present invention includes a handle restriction unit that restricts a turning range of the handle within a predetermined range.

In the foregoing configuration, the lifting clamp according to the present invention is configured such that the handle restriction unit can accommodate the handle only in a direction of reducing the pressing force.

### Advantageous Effects of Invention

As described above, according to the present invention, if the handle is moved to turn about the spindle, this turning movement is converted into a pressing movement of the contact unit toward the inside of the gripping space. With such a configuration, if the attachment angle of the handle is set such that a pressing force sufficient to grip the portion to be gripped of the object to be transported is obtained at a handle position in a lifting state, a gripping pressure on the object to be transported is generated simultaneously with the lifting operation. The object to be transported can thus be stably slung up by only the lifting operation without an additional gripping or fixing operation on the object to be transported.

According to the present invention, in addition to the foregoing effect, the end cam is disposed on the opposite piece of the main body, and the follower that can be designed to be relatively lightweight is disposed integrally with the handle and the spindle. This configuration can lighten a burden of handle operation.

According to the present invention, in addition to the foregoing effect, the cylindrical cam is disposed on the opposite piece of the main body, and the follower that can be designed to be relatively lightweight is disposed integrally with the handle and the spindle. This configuration can lighten the burden of the handle operation.

According to the present invention, in addition to the foregoing effects, the distance to the contact unit is adjusted by the adjustment unit disposed on at least either one of the opposite pieces. The gripping width can thus be changed on site depending on the object to be transported. This improves versatility and work efficiency.

According to the present invention, in addition to the foregoing effects, the handle has at least one depressed portion outward in the radial direction of the turning. The lifting state can thus be stabilized and constant gripping pressure can be maintained by engaging a rope or the like with the depressed portion.

According to the present invention, in addition to the foregoing effects, the one-way clutch that allows rotation only in the direction of increasing the pressing force is provided between the spindle and the main body. A locking position can thus be selected in a stepless manner while increasing the pressing force. As a result, a stable gripping state can be formed by simply rotating the spindle to a position where an optimum pressing force occurs.

According to the present invention, in addition to the foregoing effects, the outer ring of the one-way clutch can be locked to the main body by the outer ring fixing unit. Thus, the one-directional locking action of the outer ring with respect to the inner ring of the one-way clutch is used in fastening the object to be transported, and the outer ring fixing unit is used for unlocking, that is, different mechanisms can be used for locking and unlocking.

According to the present invention, in addition to the foregoing effects, the spindle is fitted to the inner ring of the one-way clutch by transition fit. The spindle can thus be slid in the inner ring by applying a force greater than a certain magnitude. As a result, an axially sliding function and a fixing function in the direction of rotation can be implemented by the same structure using the low resistance of the one-way clutch in the allowed direction of rotation.

According to the present invention, in addition to the foregoing effects, the turning range is restricted within the predetermined range once the handle is accommodated in the handle restriction unit. A constant distance between the two contact units can thereby be maintained. Such a transformation into the accommodation state with less movable units facilitates handling in a state where the object to be transported is not gripped. Positioning to the object to be transported is also facilitated.

According to the present invention, in addition to the foregoing effects, accommodation of the handle by the handle restriction unit is possible only in the direction of reducing the pressing force. When removing the lifting clamp after transportation, the gripping can thus be released by turning the handle in the direction of reducing the pressing force, and the handle can be fixed within a predetermined range (range where a grip released state can be maintained) at the same time. Since the fixed handle will not return even if simply slung up, the lifting clamp can be removed by simply lifting the handle without holding the object to be transported.

### BRIEF DESCRIPTION OF DRAWINGS

FIG. 1 is an overall perspective view of a lifting clamp according to a first embodiment of the present invention.

FIG. 2 is a perspective view showing a state where a cam unit and a contact unit of the lifting clamp of FIG. 1 are exploded.

FIG. 3 is an explanatory operation diagram of a cam mechanism of the lifting clamp of FIG. 1.

FIG. 4 is a diagram showing a use state of the lifting clamp of FIG. 1.

FIG. 5 is a side view showing use states of the lifting clamp of FIG. 1.

FIG. 6 is a diagram showing the vicinity of a contact unit on a side opposite to the cam unit, including an adjustment mechanism.

FIG. 7 is a diagram showing a first modification of the cam unit of the lifting clamp of FIG. 1.

FIG. 8 is a diagram showing a second modification of the cam unit of the lifting clamp of FIG. 1.

FIG. 9 is an overall perspective view of a lifting clamp according to a second embodiment of the present invention.

FIG. 10 is a diagram showing an operation of a handle restriction unit of the lifting clamp of FIG. 9.

FIG. 11 is an exploded perspective view of the lifting clamp of FIG. 9.

FIG. 12 is a diagram showing operation of a one-way clutch of the lifting clamp of FIG. 9.

FIG. 13 is a cross-sectional view showing the operation of the one-way clutch of the lifting clamp of FIG. 9, taken in parallel with a spindle.

FIG. 14 is a diagram showing an operation procedure for using the lifting clamp of FIG. 9.

FIG. 15 is a diagram showing a modification of the lifting clamp of FIG. 9.

FIG. 16 is a diagram showing a conventional panel clamp. Description of Embodiments

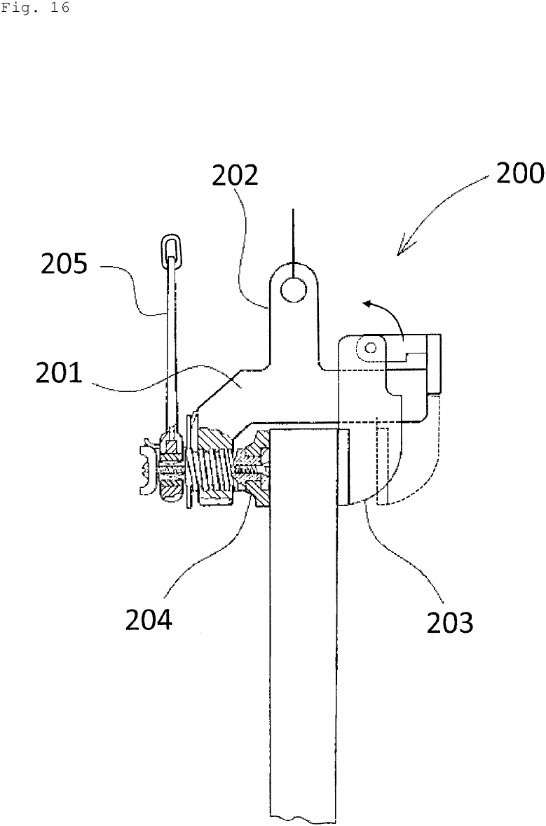

Lifting clamps according to embodiments of the present invention will be described below with reference to the drawings.

### FIRST EMBODIMENT

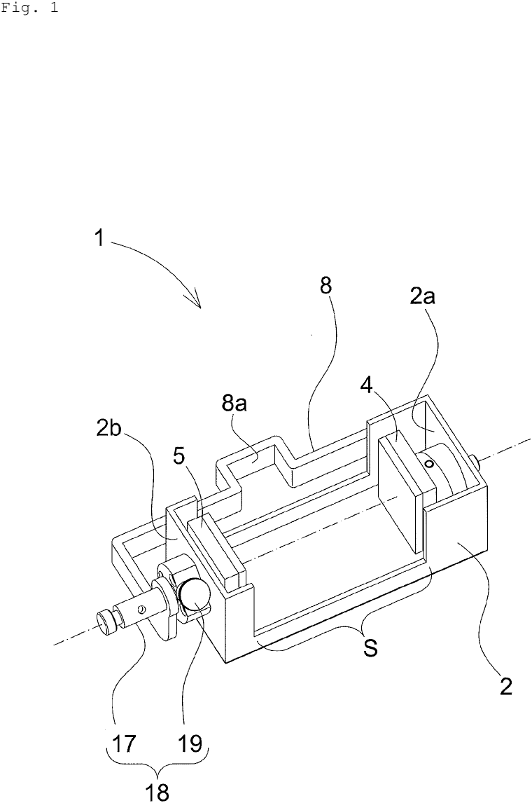

FIG. 1 is an overall perspective view of a lifting clamp 1 according to an embodiment of the present invention. A main body 2 of the lifting clamp 1 includes a pair of opposite pieces 2a and 2b opposed so as to form a gripping space S for gripping an object to be transported. Two contact units 4 and 5 are provided opposite to each other on the gripping space S sides of the pair of opposite pieces 2a and 2b, respectively.

In a gripping state, the two contact units 4 and 5 contact the object to be transported.

A cam unit 10 is provided between the non-contacting side of one of the contact units, the contact unit 4, and the opposite piece 2a. As will be described below, the cam unit 10 is a mechanism for pushing the contact unit 4 toward the gripping space S to cause a pressing force.

No mechanism corresponding to the cam unit 10 is disposed on the non-contact side of the other contact unit 5. In the gripping state, the contact unit 5 is fixed at a predetermined position.

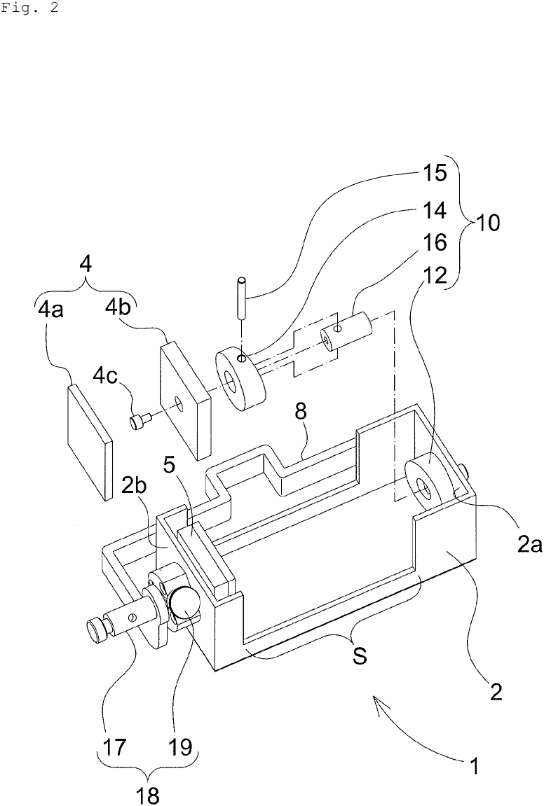

A handle 8 is attached outside the main body 2. The handle 8 is attached rotatably about a spindle 16 (to be described below with reference to FIG. 2) and a spindle 17, both spindles being disposed on the main body 2. The spindles 16 and 17 are arranged so as to extend along a gripping direction shown by a dot-dashed line in FIG. 1. FIG. 1 shows only the spindle 17 on the side connected to the fixed contact unit 5.

FIG. 2 shows a perspective view where the cam unit 10 and the contact unit 4 of the lifting clamp 1 of FIG. 1 are exploded.

An end cam 12 constituting the cam unit 10 is fixed to the opposite piece 2a of the main body 2. The spindle 16 is arranged so as to pass through the center of the end cam 12. The outside (opposite piece 2a side) end of the spindle 16 is connected to the handle 8. The spindle 16 thus rotates axially with the turning of the handle 8.

Meanwhile, a follower 14 to slide over the end cam 12 is formed in a cylindrical shape. The end of the spindle 16 on the gripping space S side opposite to the side connected to the handle 8 is arranged so as to run through the follower 14. The spindle 16, which is arranged so as to run through the follower 14, and the follower 14 are integrally fixed by a fixing pin 15 disposed so as to run through in a direction orthogonal to the gripping direction. As a result, the follower 14 also rotates together as the spindle 16 rotates with the handle 8.

The contact unit 4 is coupled to the follower 14 in the gripping space S side with a screw 4c. The contact unit 4 and the follower 14 are rotatably coupled to each other. Accordingly, when the handle 8, the spindle 16, and the follower 14 rotate integrally, only the contact unit 4 can remain unrotated and maintain its relative positional relationship with the object to be transported. As shown in FIG. 2, this contact unit 4 includes a contact member 4a to contact the object to be transported and a base 4b. While the contact member 4a here is shown in a plate-like shape, a surface treatment may be applied to increase friction coefficient with the object to be transported. A buffer member may be used to avoid damaging the object to be transported in a gripping state. The contact unit 4 may be formed of a single member if configured to be rotatable relative to the spindle 16.

In such a manner, the cam unit 10 is disposed between the contact unit 4 and the opposite piece 2a, wherein the cum unit 10 serves as a conversion unit for converting a rotational force caused by the turning of the handle 8 into a pressing force toward the inside of the gripping space S.

The contact unit 5 on a side without a cam mechanism has a configuration similar to that of the contact unit 4. This contact unit 5 is attached so as to freely rotate relative to the spindle 17 protruding outward.

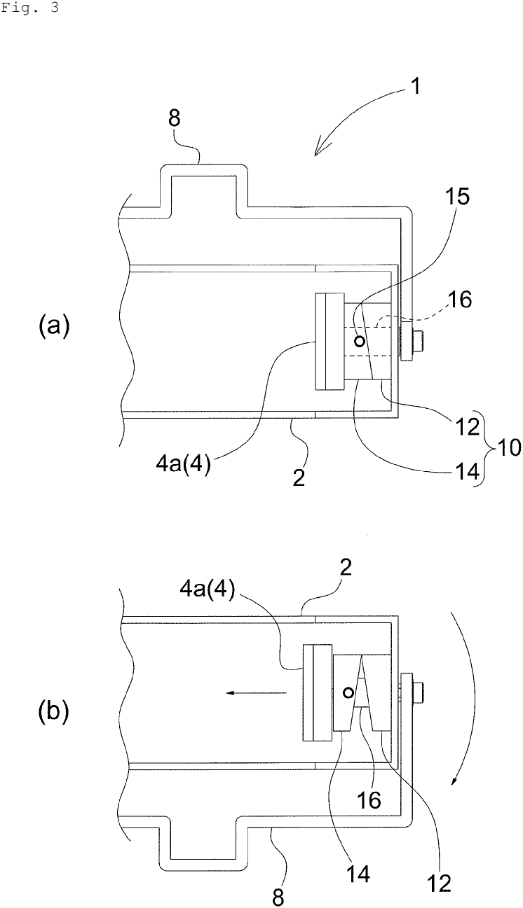

An operation of the cam mechanism of the lifting clamp 1 will be described with reference to FIG. 3.

FIG. 3(a) shows a state where a gripping distance is maximized. FIG. 3(b) shows a state where the gripping distance is minimized. As employed herein, the gripping distance refers to a distance resulting from the displacement of the cam mechanism with the other fixed-side contact unit 5 (see FIG. 1) maintained at a constant position.

In the configuration according to the present embodiment, if the handle 8 is rotated 180° from a state of FIG. 3(a) to a state of FIG. 3(b), part of the follower 14 slides along the end cam 12, whereby the contact unit 4 is pushed to the gripping side and the gripping distance is minimized.

Moreover, the contact unit 4 is formed in such a size as to contact an inner side of the main body 2. Even if the follower 14 rotates with the handle 8, only the contact unit 4 thus interferes with the inner side of the main body 2 and can thereby be prevented from rotating together. However, the configuration of the contact unit is not limited to the foregoing configuration, and the contact unit 4 may be formed in a shape not to interfere with the inner side of the main body 2. In such a case, contact of the contact member 4a of the contact unit 4 with the object to be transported can provide a frictional force to prevent the integral rotation.

Although not shown, employment of a configuration for biasing the follower 14 back toward the opposite piece 2a can facilitate an operation of installing the lifting clamp 1 on the object to be transported.

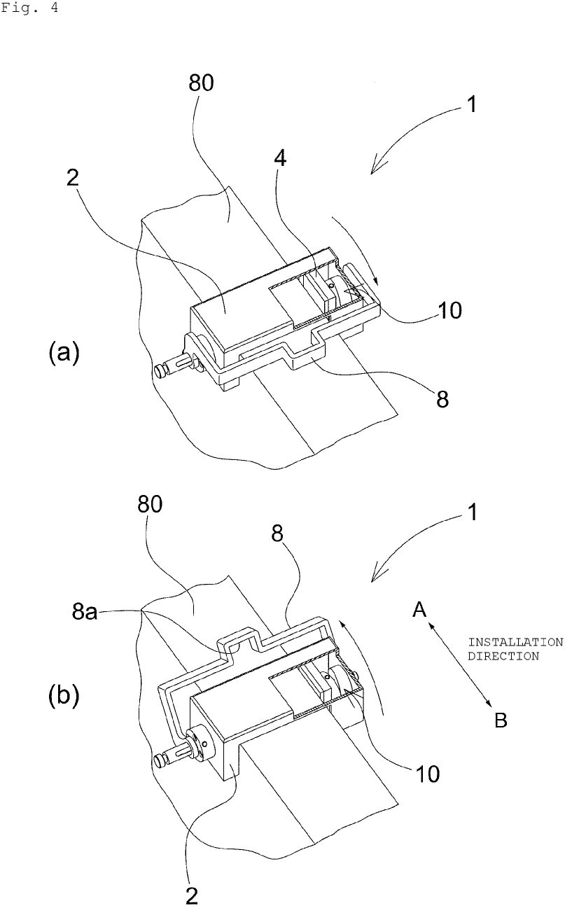

FIG. 4 shows a use state of the lifting clamp 1.

For convenience of description, FIG. 4 shows only part of a plate-like object to be transported 80. Moreover, the main body 2 is shown partly broken to show movement of the cam mechanism of the cam unit 10 in the lifting clamp 1. The object to be transported 80 is arranged so as to extend in an installation direction of the lifting clamp 1 shown by arrows.

FIG. 4(a) corresponds to a state of FIG. 3(a). FIG. 4(b) shows an intermediate stage to reach the state of FIG. 3(b). That is, the lifting clamp 1 is set to produce a sufficient clamping force on the object to be transported 80 at a turning position before the gripping distance between the two contact units 4 and 5 (see FIG. 1) is minimized.

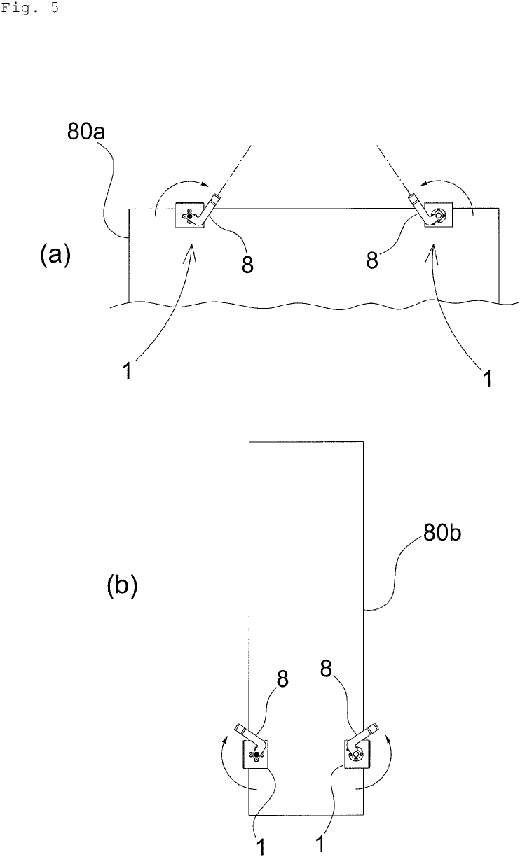

FIG. 5 is a side view showing use states of the lifting clamps 1. FIG. 5(a) shows a state where a panel member 80a that is an object to be transported is lifted. In a state of the lifting clamps 1 being arranged in a manner shown in FIG. 5(a), an A side of the installation direction shown in FIG. 4(b) corresponds to each side of the opposite lifting clamps 1 of the respective lifting clamps 1.

When the handles 8 are tightened toward a center of the panel member 80a, turning of the handles 8 is restricted in a middle way by clamping pressure and the handles 8 stop at the turning positions shown by the dot-dashed lines. If a rope is stretched to connect the two lifting clamps 1 in the directions of the dot-dashed lines and slung up by a crane hook, the main bodies 2 sides of the lifting clamps 1 are pulled down by action due to own weight of the panel member 80a. The relative rotation positions of the handles 8 with respect to the main body 2 are thereby fixed with pressure in a fastening direction, whereby a clamping state can be stably maintained.

In the configuration according to the present embodiment, a depressed portion 8a is formed in a center of the handle 8 to be depressed outward in a radial direction of turning as described above. With such a configuration, if the lifting clamp 1 is used with a rope to hang the handle 8 and the rope is accommodated in the depressed portion 8a, a center position of the lifting clamp 1 can be stably maintained. This stabilizes the transportation operation since gripping pressure applied on the object to be transported 80 from the handle 8 via the cam unit 10 can be maintained in a constant manner.

In the present embodiment, a configuration where the portions of the handle 8 on both sides of the depressed portion 8a are shaped straight in parallel with the gripping direction has been described as an example. However, if these portions are configured to slope in a bell shape with the depressed portion 8a at the vertex such that a distance between the both portions in a gripping direction decreases toward the depressed portion 8a, the rope is automatically guided into the depressed portion 8a simultaneously with the lifting operation. This enables the rope to support the center of the gripping area without fail.

FIG. 5(b) shows a state where the lifting clamps 1 are arranged at sides of a panel member 80b. The configuration according to the present embodiment can thus be used not only for vertical slinging in FIG. 5(a) but also for lateral slinging as in FIG. 5(b).

Large-sized panel members used at construction sites can include ones that are light enough in weight for an operator to lift but are too bulky to manually do so. In such a case, if the lifting clamps 1 are arranged at the sides of the panel member 80b such that the lifting clamps 1 can be fastened upward, upward turning of the handles 8 is restricted, and the panel member 80b can be manually transported by holding the handles 8 of the lifting clamps 1.

Specifically, the lifting clamps 1 are attached to the sides of the panel member 80b with the gripping distances maximized and the handles 8 down as shown in FIGS. 3(a) and 4 (a). The handles 8 are then turned up to be lifted, whereby the lifting clamps 1 are brought into the clamping state at the position of FIG. 4(b) before reaching the state of FIG. 3(b), and the turning of the handles 8 is restricted.

With the lifting clamps 1 installed in such a manner, the panel member 80b can be held in a stable clamping state and safely transported as long as the handles 8 are held up. The clamping state is released by simply placing the panel member 80b on the ground or the like at a transport destination and lowering the handles 8. The lifting clamps 1 can thus be detached easily without a special detachment operation. The absence of complicated fastening and releasing operations for attachment and detachment significantly improves the work efficiency.

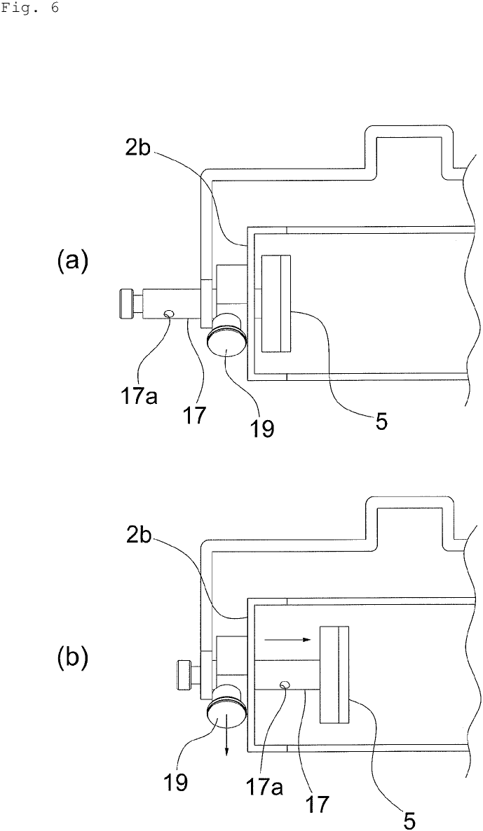

FIG. 6 shows a vicinity of the contact unit 5, which is equipped with an adjustment mechanism, on a side opposite to a contact unit 4 side where the cam unit 10 is disposed (see FIG. 3). FIG. 6(a) shows a state where the gripping distance is widened. FIG. 6(b) shows a state where the gripping distance is narrowed.

In the configuration according to the present embodiment, the spindle 17 is arranged to run through the opposite piece 2b of the main body 2 and configured to be slidable in the gripping direction.

A plunger 19 (the adjustment unit 18 (see FIG. 1)) is provided outside the opposite piece 2b. The contact unit 5 can be fixed at a predetermined distance by selectively fitting the plunger 19 to one of a plurality of positioning holes 17a formed in the spindle 17. While the configuration shown in FIG. 6 demonstrates an example where two positioning holes 17a are formed in the spindle 17, three or more positioning holes 17a may be formed depending on a type of the object to be transported to handle.

With the configuration according to the present embodiment, the position of the contact unit 5 can be quickly changed by operating the plunger 19. The objects to be transported with different sizes can thus be easily handled.

### Modifications

First and second modifications of the cam unit will be described below. Here, similar components to those of the lifting clamp 1 described above will be described with the same reference numerals.

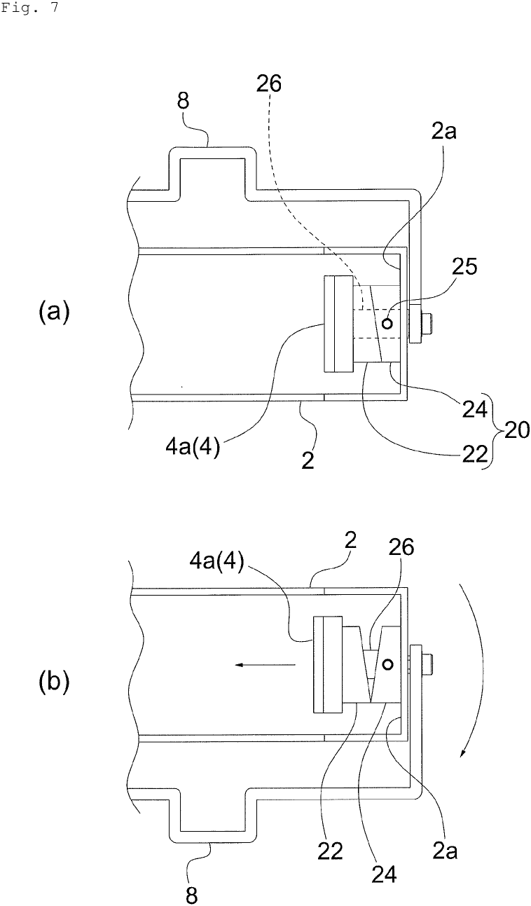

FIG. 7 shows a configuration where a cam unit 20 includes an end cam 22 as the first modification of the lifting clamp 1 of FIG. 1. This configuration is different from the one where the end cam 12 is fixed to the opposite piece 2a of the main body 2 as shown in FIGS. 2 and 3.

In FIG. 7, a follower 24 is disposed on the opposite piece 2a. More specifically, the follower 24 on the opposite piece 2a side is integrally fixed to a spindle 26 connected to the handle 8 by a fixing pin 25. Meanwhile, the end cam 22 is integrated with the contact unit 4.

In such a configuration, when the handle 8 is turned to rotate the follower 24 with the spindle 26, part of the follower 24 slides along the end cam 22. This action pushes the end cam 22 in the gripping direction relative to the follower 24, whereby the object to be transported can be gripped.

The configuration shown in FIG. 7 can be implemented if the end cam 22 is coupled with the spindle 26 so as to be slidable in the gripping direction and rotatable with respect to the spindle 26.

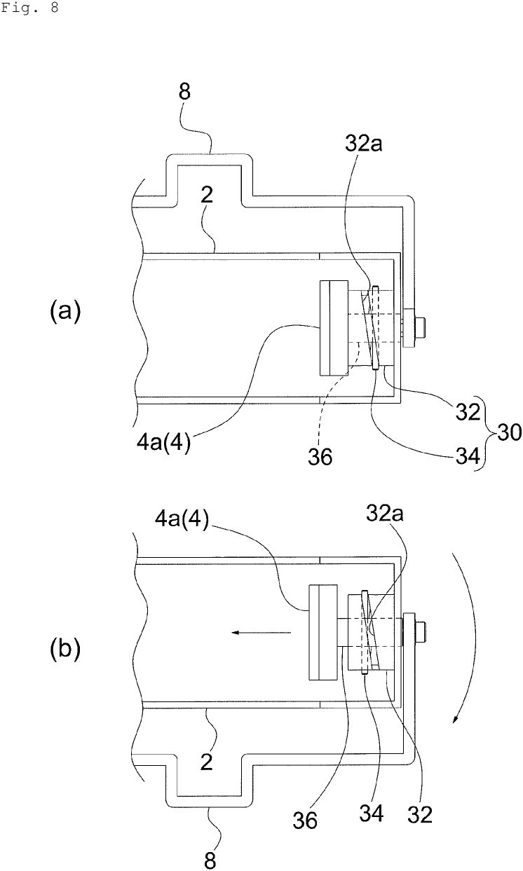

FIG. 8 shows a configuration where a cam unit 30 includes a cylindrical cam 32 as the second modification of the lifting clamp of FIG. 1.

The cylindrical cam 32 has long guide holes 32a helically extending in the gripping direction over a rotation range of 180°. Such long guide holes 32a are formed in the side surface of the cylinder so as to be opposed to each other. Helical directions of the long guide holes 32a extending in the gripping direction with respect to a certain rotation direction are identical and not mirror-symmetrically.

A follower pin 34 that is the follower is arranged so as to run through both the long guide holes 32a formed opposite to each other. The follower pin 34 is integrally provided to run through the spindle 36. When the handle 8 is turned to axially rotate the spindle 36, the follower pin 34 rotates with the spindle 36 and moves in the gripping direction while tracing a helical path along the long guide holes 32a. The spindle 36 is configured to be slidable in the gripping direction with respect to the handle 8.

The modification shown in FIG. 8 demonstrates the configuration where the long guide holes 32a are formed as a guide structure of the cylindrical cam 32 as an example. However, a helically grooved guide may be employed instead of the long guide hole 32a.

If a grooved configuration is thus employed as a guide, either of the configurations where the follower slides inside the cylindrical cam and where the follower slides outside the cylindrical cam may be used.

With such a configuration, turning the handle 8 pushes the contact unit 4 to the gripping side along with the spindle 36. The same effects as those of the lifting clamp 1 of FIG. 1 can be obtained even with the configurations of the modifications in FIGS. 7 and 8.

### SECOND EMBODIMENT

Next, a lifting clamp according to a second embodiment will be described. Components different from those of the lifting clamp 1 according to the first embodiment will be mainly described. A description of similar components will be omitted.

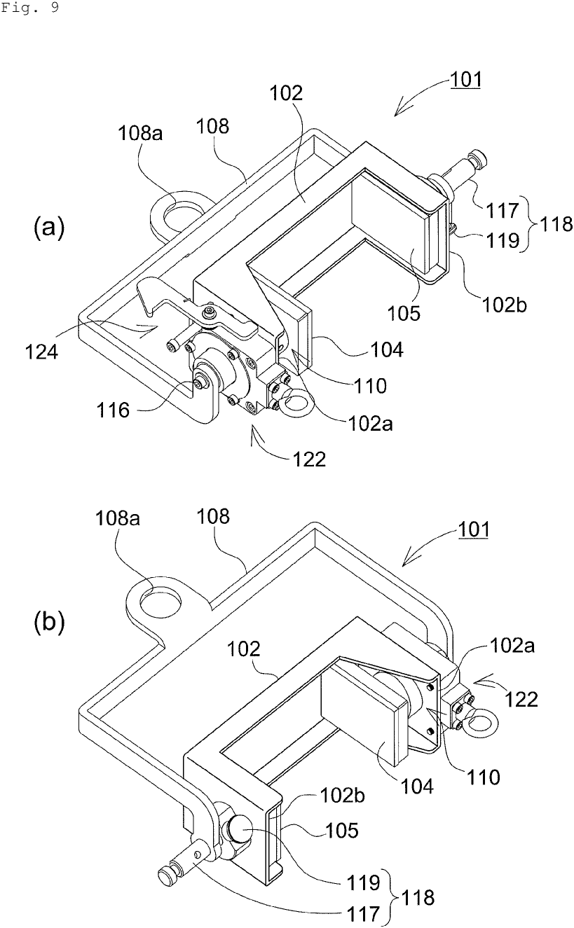

FIG. 9 is an overall perspective view of the lifting clamp according to the second embodiment of the present invention. FIG. 9(a) shows a front side of the lifting clamp, and FIG. 9(b) a back side. For the sake of convenience, in the following description, a side where a handle restriction unit (to be described below) is attached is referred to as the front side.

Contact units 104 and 105, a cam unit 110 (conversion unit), and an adjustment unit 118 have configurations similar to those of the lifting clamp 1 of FIG. 1.

A handle 108 has almost the same outer shape as that of the handle 8 of the lifting clamp 1 of FIG. 1, whereas a hanging hole portion 108a is provided instead of the depressed portion 8a for catching a rope. This makes the relative position of the rope to the lifting clamp 101 constant for stable transportation operation.

Two mechanisms for restricting movement of a spindle 116 with respect to a main body 102 are disposed on the contact unit 104 side different from the contact unit 105 side where the adjustment unit 118 is disposed. One is a mechanism for restricting the spindle 116 at unspecific rotational positions with respect to the main body 102. Specifically, an outer ring fixing unit 122 disposed outside an opposite piece 102a of the main body 102 on the contact unit 105 side corresponds to this mechanism. A detailed structure and operation of the outer ring fixing unit 122 will be described in detail below.

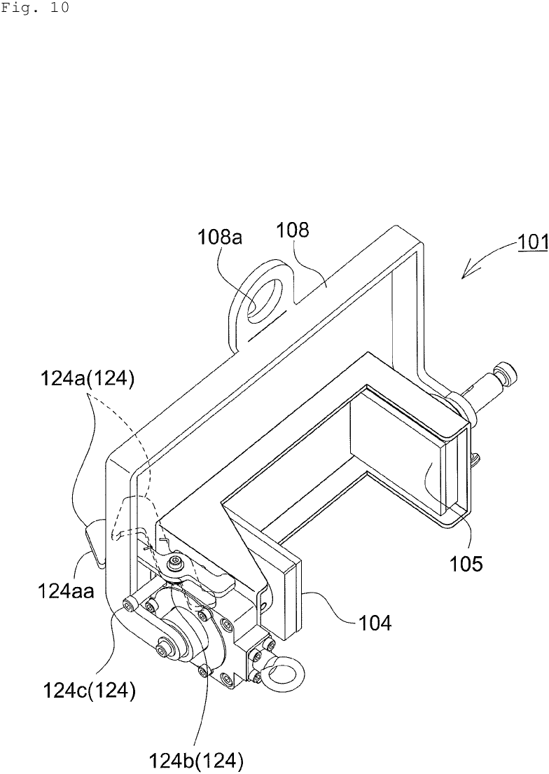

The other mechanism is one for restricting the spindle 116 at a specific rotational position with respect to the main body 102. Specifically, a handle restriction unit 124 attached to the outer ring fixing unit 122 corresponds to this mechanism. The handle restriction unit 124 will be described with reference to FIG. 10.

FIG. 10 is a diagram showing operation of the handle restriction unit 124. The handle restriction unit 124 includes a latch 124a and a restriction pin 124c. The latch 124a is rotatably attached to an outer surface of a housing 122a of the outer ring fixing unit 122. A spring 124b is disposed around a rotation shaft of the latch 124a. The spring 124b biases the latch 124a in a direction to intersect a turning path of the handle 108 from inside to outside. With no external force applied, a hooked end of the latch 124a is biased by the spring 124b to protrude to a position where the latch 124a can intersect the turning path of the handle 108. In turning the handle 108 beyond the latch 124a, the latch 124a can be retracted against biasing of the spring 124b. In FIG. 10, the latch 124a in a state of being retracted from the turning path of the handle 108 is shown by dotted lines.

In the configuration according to the present embodiment, a portion at the end of the latch 124a where the handle 108 contacts while turning in the direction of reducing the pressing force on the object to be transported is formed to slant at an angle to promote retraction. By contrast, a side to contact the handle 108 turning in the direction for increasing the pressing force on the object to be transported is shaped to prevent the retraction. If the handle 108 is turned in the direction to cancel the gripping state, the latch 124a can thus be automatically retracted by sliding the handle 108 over a slope portion 124aa of the latch 124a.

Of the components of the handle restriction unit 124, the restriction pin 124c for restricting the turning of the handle 108 along with the latch 124a is protruded to a position intersecting the turning path of the handle 108 like the latch 124a. This restriction pin 124c contacts the handle 108 at a position different from a position where the latch 124a does. In the configuration according to the present embodiment, the restriction pin 124c is arranged to contact the handle 108 at a position where the pressing force of the contact unit 104 acting on the object to be transported is smaller, compared to the latch 124a. Unlike the latch 124a, the restriction pin 124c is not retractable. The handle 108 is therefore unable to be turned beyond the restriction pin 124c.

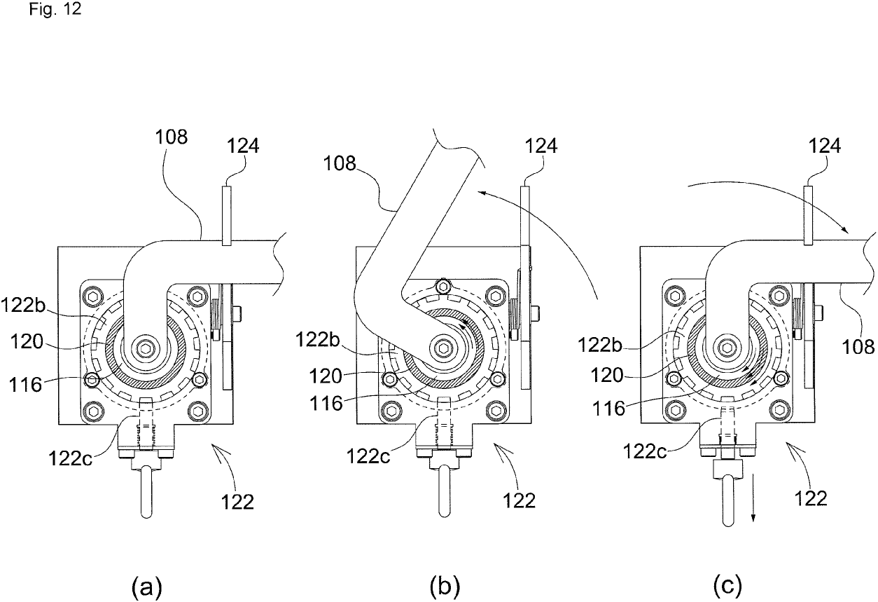

With such a configuration, the handle 108 can be turned freely outside the handle restriction unit 124. Moreover, the handle 108 can be fixed between the latch 124a and the restriction pin 124c (inside the handle restriction unit 124) by turning the handle 108 to a position beyond the latch 124a. By fixing the turning position of the handle 108 with the handle restriction unit 124 at an initial setting for attachment of the lifting clamp 101 to the object to be transported, its posture is stabilized even if slung up using the hanging hole portion 108a of the handle 108. In addition, the positioning during the attachment to the object to be transported is facilitated since the distance between the two contact units 104 and 105 is fixed. Next, an internal structure of the outer ring fixing unit 122 will be described with reference to FIG. 12.

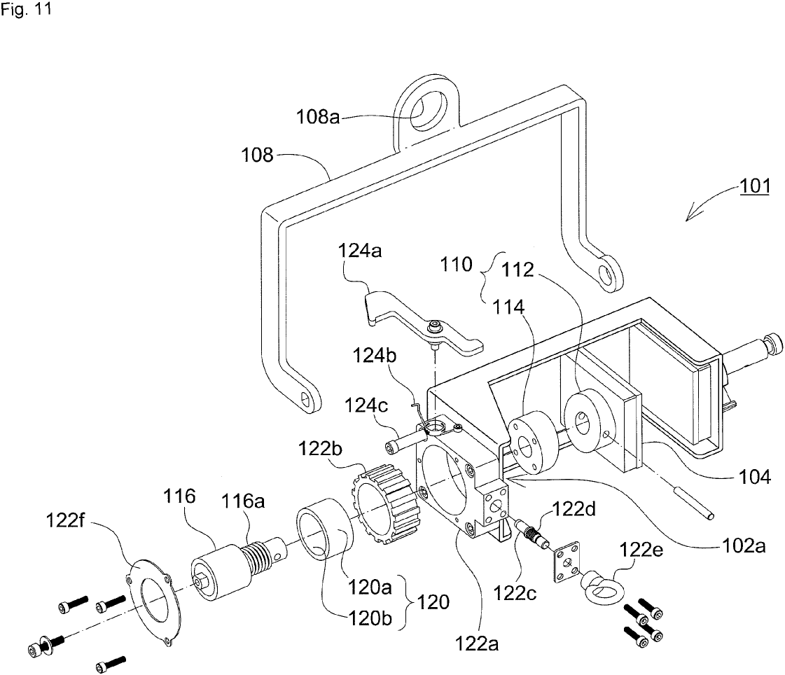

FIG. 11 is an exploded view of the outer ring fixing unit 122 of the lifting clamp 101.

The housing 122a of the outer ring fixing unit 122 is fixed outside the opposite piece 102a to which the contact unit 104 is attached.

A ring-shaped rotation stopper 122b having teeth on its outer diameter side is accommodated in the housing 122a. A one-way clutch 120 is further accommodated in the rotation stopper 122b. For the convenience of description, the one-way clutch 120 here is schematically shown as a cylinder. In fact, the one-way clutch 120 includes an outer ring 120a and an inner ring 120b, and is configured so that a relative rotation between the outer ring 120a and the inner ring 120b is allowed only in one direction. The outer ring 120a of the one-way clutch 120 is fixed to the rotation stopper 122b.

The spindle 116 is slidably accommodated in the inner ring 120b of the one-way clutch 120. Like the lifting clamp 1 described in the first embodiment, a gripping space-side end of the spindle 116 is fixed to an end cam 112 of the cam unit 110 to constitute a conversion unit that converts axial rotation into a force acting in the gripping direction.

The rotation stopper 122b, the one-way clutch 120, and the spindle 116 are concentrically arranged and accommodated in the housing 122a, which is closed by a lid plate 122f.

A rotation stopper pin 122c is inserted in the housing 122a in a direction orthogonal to the spindle 116. The rotation stopper pin 122c is arranged such that its end can be engaged with a depressed portion in an outer side of the rotation stopper 122b. For easy operation, an eyenut 122e is attached to an outer end of the rotation stopper pin 122c. Next, operation of this outer ring fixing unit 122 will be described.

FIG. 12 shows axial views of the outer ring fixing unit 122. FIG. 12(a) shows an initial state where the handle 108 is fixed by the handle restriction unit 124, FIG. 12(b) shows a state where the object to be transported is fixed, and FIG. 12(c) shows a state where fixing of the object to be transported is released. For the convenience of description, the outer ring fixing unit 122 is shown with the lid plate 122f transparent so that the internal structure can be seen. Moreover, the one-way clutch 120 is shown with hatching to clarify borders between parts.

In the initial state of FIG. 12(a), it can be seen that the end of the rotation stopper pin 122c is engaged with the depressed portion of the rotation stopper 122b and the rotation stopper 122b is fixed to the housing 122a. As described above, the outer ring 120a (see FIG. 11) of the one-way clutch 120 is integrally fixed to the inner side of the rotation stopper 122b. In the configuration according to the present embodiment, the one-way clutch 120 is arranged to allow rotation only in the direction of increasing the pressing force when the handle 108 is operated to grip the object to be transported. In FIG. 12(a), the one-way clutch 120 is set to allow the rotation of the spindle 116 only when the handle 108 turns counterclockwise.

FIG. 12(b) shows a state where the handle 108 is rotated in the direction of increasing the pressing force (counterclockwise) to fix the object to be transported. As described above, since the one-way clutch 120 allows relative rotation in the direction of increasing the pressing force, the inner ring 120b (see FIG. 11) of the one-way clutch 120 rotates with the spindle 116 counterclockwise. Here, the rotation stopper 122b is fixed to the housing 122a by the engagement of the rotation stopper pin 122c. The outer ring 120a of the one-way clutch 120 therefore also remains stationary. In the state of FIG. 12(b), the object to be transported gripped can be slung up and moved. As with the adjustment unit 18 described with reference to FIG. 6 in the first embodiment, adjusting the adjustment unit 118 (see FIG. 9) of the lifting clamp 101 in advance such that the object to be transported can be fixed by operating the handle 108 within 900, the object to be transported can be stably gripped when the handle 108 is lifted as shown in FIG. 12(b).

FIG. 12(c) shows a state in which the handle 108 is returned to an initial position where the handle restriction unit 124 is provided to release the fixing of the object to be transported. After the object to be transported is transported to the intended place, the fixing of the object to be transported needs to be released by returning the handle 108 as shown in FIG. 12(c). However, as described above, the one-way clutch 120 allows the relative rotation between the outer ring 120a and the inner ring 120b only in the direction of increasing the pressing force on the object to be transported. In the clockwise direction where the pressing force is reduced to release the fixing, the spindle 116, the one-way clutch 120, and the rotation stopper 122b therefore do not make a relative rotation and remain integral. In other words, since the rotation stopper 122b is fixed by the rotation stopper pin 122c, the turning of the handle 108 is restricted. The rotation stopper pin 122c is then lowered and withdrawn from the depressed portion of the rotation stopper 122b, whereby the fixing of the rotation stopper 122b to the housing 122a is released. This enables integral rotation of the spindle 116, the one-way clutch 120, and the rotation stopper 122b with the handle 108 clockwise. The object to be transported is thus freed from the pressing force. Next, a relationship between the cam unit 110 and the spindle 116 will be described.

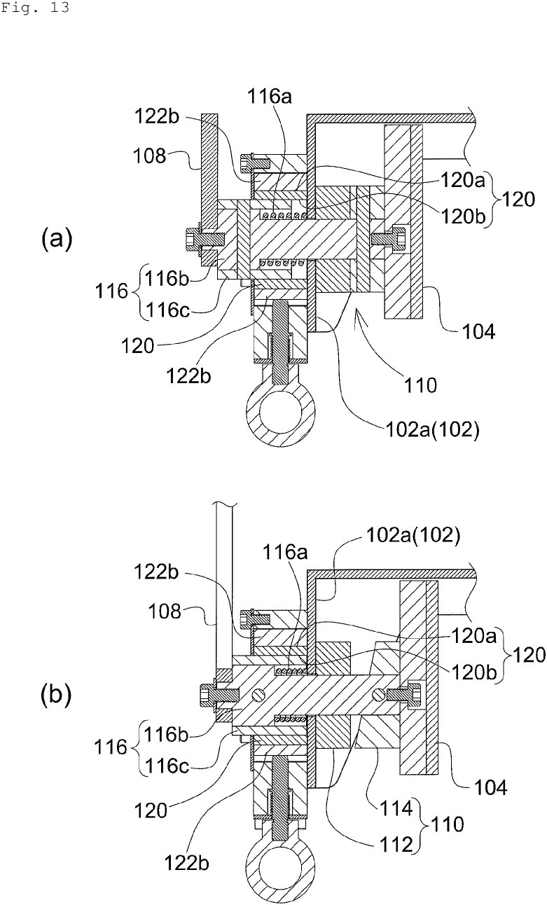

FIG. 13 shows cross-sectional views taken along an extending direction of the spindle 116. FIG. 13(a) shows a state where the gripping space is maximized (the foregoing initial state). FIG. 13(b) shows a state where the handle 108 is rotated 90° in the direction of increasing the pressing force of the contact unit 104 on the object to be transported.

It can be seen from a comparison between FIGS. 13(a) and 13(b) that as the handle 108 is rotated in the gripping direction, a follower 114 of the cam unit 110 separates from the end cam 112 while helically moving its contact point. As a result, the spindle 116 integrally fixed to the follower 114 also slides axially.

As described above, the inner ring 120b of the one-way clutch 120 and the spindle 116 are slidably disposed. The spindle 116 can thus slide inside the one-way clutch 120 depending on a transformation of the cam unit 110. A spring 116a is disposed between the spindle 116 and the opposite piece 102a (main body 102). With the handle 108 returned, the spindle 116 therefore returns to its original position, and the follower 114 to an initial location as well.

By the way, the state of FIG. 13(b) corresponds to that of FIG. 12(b). In other words, the spindle 116 slides relative to the one-way clutch 120 axially while rotating integrally with the one-way clutch 120 in a direction of rotation. In the configuration according to the present embodiment, the spindle 116 is fitted to the inner ring 120b of the one-way clutch 120 by transition fit. Specifically, fit tolerance of the spindle 116 with respect to the one-way clutch 120 is set at fit tolerance h6.

With such a configuration, the spindle 116 can slide on the inner ring 120b to move axially. In the rotation direction for increasing the pressing force as shown in FIG. 12(b), a rolling resistance between the outer ring 120a and the inner ring 120b of the one-way clutch 120 is lower than a sliding resistance between the surfaces of the inner ring 120b and the spindle 116. The inner ring 120b can thus rotate integrally with the rotation of the spindle 116.

To implement such movement, a key-and-keyway structure may be provided between the inner ring 120b and the spindle 116. However, adjusting the fit tolerance as in the configuration according to the present embodiment can facilitate machining and reduce cost.

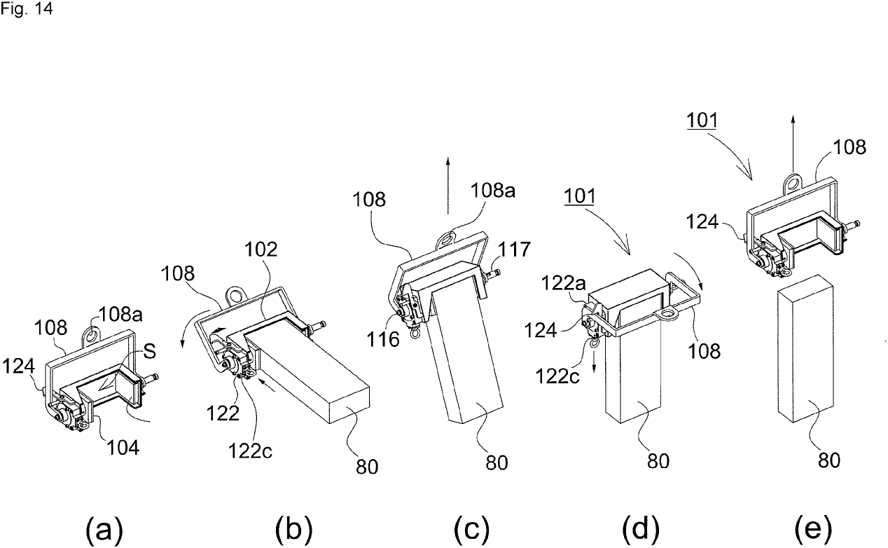

FIG. 14 is a diagram for describing a procedure for a transportation operation. FIG. 14(a) shows an initial state, FIG. 14(b) shows a gripping step, FIG. 14(c) shows a lifting and transportation step, FIG. 14(d) shows a gripping release step, and FIG. 14(e) shows a removal step. In a following description of an operation procedure, FIGS. 12 and 13 will be referred to for the internal structure as appropriate.

As shown in FIG. 14(a), a situation where the handle 108 is fixed by the handle restriction unit 124 will be referred to as an initial state. With the handle 108 fixed thus, the lifting clamp 101 is stably hanged using the hanging hole portion 108a since there is no needless movable portion. Since the distance between the opposed contact units 104 and 105 can be maintained constant, positioning to the object to be transported is facilitated.

In FIG. 14(b), a portion to be gripped of the object to be transported 80 is accommodated in the gripping space S of the main body 102. In such a state, the rotation stopper pin 122c of the outer ring fixing unit 122 is pushed in, whereby the rotation stopper 122b is fixed to the housing 122a. The handle 108 is then turned with the latch 124b of the handle restriction unit 124 retracted, whereby the object to be transported 80 is gripped. Here, the rotation in the direction of increasing the pressing force is allowed by the action of the one-way clutch 120 (see FIG. 12), whereas the rotation in the loosening direction is restricted. The object to be transported 80 is thus stably gripped when gripped with appropriate pressing force even with hands off. Since the one-way clutch 120 can change a locking position in a stepless manner, the object to be transported 80 can be held with just enough optimum gripping pressure.

In FIG. 14(c), the object to be transported 80 held with appropriate gripping pressure is slung up. The handle 108 is locked by the one-way clutch 120 and is thus stably fixed in both rotation directions. Gripping the object to be transported 80 such that the spindle 116 (or 117), the hanging hole portion 108a, and the overall center of gravity including the object to be transported 80 are not aligned in a straight line in order to leave a fastening margin enables a stable transportation operation without loosening partway, since force in the direction of increasing the pressing force due to operation of the handle 108 continues acting when the object to be transported 80 is slung up.

FIG. 14(d) shows a state where the object to be transported 80 is moved to the intended place and then the gripping state is released. Pulling the rotation stopper pin 122c from the housing 122a releases fitting of the stopper pin 122c to the rotation stopper 122b inside. This enables free rotation of the handle 108. If the handle 108 is rotated beyond the latch 124a of the handle restriction unit 124, the gripping force on the object to be transported 80 disappears and the lifting clamp 101 can be detached.

FIG. 14(e) shows a state where the lifting clamp 101 back to a posture of the initial state as shown in FIG. 14(a) is simply lifted. The lifting clamp 101 can thus be lifted and easily separated from the object to be transported 80 since the handle 108 is fixed by the handle restriction unit 124.

The transportation operation can be performed through such a procedure. With ropes or rod members capable of remote operation connected to the handle 108 and the rotation stopper pin 122C, an operator can single-handedly transport the object to be transported 80 to a remote location. For example, in a case of transporting a material or the like from below to an upper floor, the operator performs the operations of FIGS. 14(a) and 14(b) at hand, and slings up the object to be transported in the step of FIG. 14(c). After the object to be transported reaches the intended upper floor, the operator lowers the object to be transported to the floor or the like and pulls the rotation stopper pin 122c and the handle 108 by remote operation from below. The gripping state can be thereby automatically cancelled, and the handle 108 can be locked by the handle restriction unit 124. The lifting clamp 101 is then lifted as shown in FIG. 14(e), whereby only the lifting clamp 101 can be retrieved while leaving only the object to be transported 80 on the upper floor.

### Modification

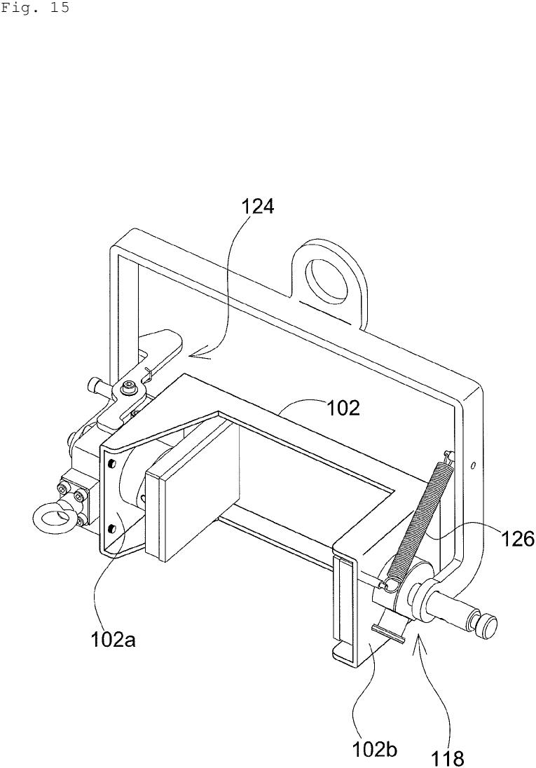

FIG. 15 shows a modification of the lifting clamp 101 of FIG. 9. A spring 126 is provided to connect the adjustment unit 118 on the opposite piece 102b side of the main body 102 and the handle 108. This spring 126 biases the handle 108 in a direction of turning the handle 108 toward the handle restriction unit 124. Providing such a spring 126 further stabilizes the initial state. In particular, in the step shown in FIG. 14(d), the operation of pulling the handle 108 toward the handle restriction unit 124 to cancel the gripping state can be assisted.

The foregoing configurations are just examples of the present invention, and the following modifications are further included.

(1) In the foregoing first embodiment, a configuration where the cylindrical follower 14 is employed for the cam unit 10 is described as an example. However, the follower 14 does not need to be cylindrical as far as the follower 14 can stably slide over the end cam 12. Moreover, the follower 14 may be configured to use rollers for sliding.

(2) In the foregoing first embodiment, a configuration where the end cam 12 is formed to surround an entire circumference of the spindle 16 is described as an example. However, the end cam 12 may be formed in a partial area around the spindle 16. If size of the gripping space S needed to accommodate the object to be transported is fixed, an area on the spindle 16 where the end cam 12 is to be formed can be designed to provide a sliding area depending on a predetermined turning angle of the handle such that a minimum necessary axial moving length is produced.

(3) In the foregoing first embodiment, a configuration where the end cam 12 has a constant inclination is described as an example. However, the inclination may vary depending on the rotation range. With such a configuration, a change in the effective moment with respect to the rotation range of the handle 8 can be corrected.

(4) In the foregoing first embodiment, a configuration where the cam unit 10 is disposed only on the opposite piece 2a side of the main body 2 is described as an example. However, cam units 10 may be disposed on both sides of the opposite pieces 2a and 2b.

(5) In the foregoing first embodiment, a configuration where the end cam 12 is designed such that maximum clamping force can be obtained at one point in the 360° range of turning of the handle 8 is described as an example. However, the end cam 12 may be designed such that peak clamping force can be obtained at a plurality of points within 360°.

(6) In the foregoing first embodiment, a configuration where the adjustment unit 18 can be adjusted in two levels using the plunger 19 is described as an example. However, the adjustment unit 18 may be configured to be adjustable in a stepless manner using a screw mechanism and the like.

(7) In the foregoing first embodiment, a configuration where the handle 8 has one depressed portion 8a is described as an example. However, the handle 8 may have more than one depressed portion or no depressed portion at all.

(8) In the foregoing first embodiment, a configuration of the cam unit 10 using an end cam mechanism is described as an example of a conversion unit for converting the rotational force of the handle 8 into the pressing force along the gripping direction. However, the cam mechanism is not essential, and a screw mechanism may be used instead. For example, a configuration where a screw shaft capable of moving back and forth in the gripping direction is threadedly disposed on the opposite piece 2a of the main body 2 and the handle is disposed integrally with the screw shaft can be employed. Such a configuration can be used to rotate the screw shaft in the fastening direction by turning the handle. This enables the operation of applying the clamping force to the object to be transported and the lifting operation at the same time by lifting the handle with turning. Moreover, if the screw pitch is set to substantially the same as the inclination of the end cam 12 of the cam unit 10 described in the foregoing embodiment, the stroke of the screw shaft in the gripping direction can be made relatively large even with less turning of the handle. This can provide similar operability to that of the end cam 12.

(9) In the foregoing second embodiment, a configuration including the end cam and the follower used in the lifting clamp 1 of FIG. 1 is described as an example of the conversion unit. However, the conversion units of FIGS. 7 and 8 may be employed for the lifting clamp 101 of FIG. 9.

(10) In the foregoing second embodiment, a configuration where the handle restriction unit for fixing the turning position of the handle is attached to the outer ring fixing unit 122 is described as an example. However, it is not limited to such a configuration of the example. As far as it is configured such that the handle position can be fixed to maintain the initial state with the two contact units away from each other, the handle restriction unit may be provided to a position other than the outer ring fixing unit 122.

(11) In the foregoing second embodiment, a configuration where the rotation stopper pin 122c for fixing and releasing the rotation of the rotation stopper 122b inside the outer ring fixing unit 122 is provided in a lower side in a hanged state is described as an example. Providing the stopper pin 122c in the lower side is advantageous as remote operation can be made from below. However, the rotation stopper pin 122c may be provided at a position other than in the lower side as far as handle operation is not interfered.

(12) In the foregoing second embodiment, a configuration where the handle restriction unit 124 includes both the latch 124a and the restriction pin 124c is described as an example. However, the two contact units can be maintained at a constant distance if the handle restriction unit 124 includes a configuration corresponding to the latch 124a that restricts the rotation in the direction of increasing the pressing force on the object to be transported. The configuration corresponding to the restriction pin 124c is therefore not indispensable.

### INDUSTRIAL APPLICABILITY

The lifting clamp according to the present invention can maintain the gripping force while the handle is kept turned to one side, and is thus useful not only for lifting purposes but also in the field of handheld operation where gripping units are attached to a material having no gripping margin.

Reference Signs List
1 lifting clamp
2 main body
2a, 2b opposite piece
4, 5 contact unit
4a contact member
4b base
4c screw
8 handle
8a depressed portion
10 cam unit (conversion unit)
12 end cam
14 follower
15 fixing pin
16, 17 spindle
17a positioning hole
18 adjustment unit
19 plunger
20 cam unit
22 end cam
24 follower
25 fixing pin
26 spindle
30 cam unit
32 cylindrical cam
32a long guide hole
34 follower pin (follower)
36 spindle
80 object to be transported
80a, 80b panel member
101 lifting clamp
102 main body
102a, 102b opposite piece
104, 105 contact unit
104a contact member
104b base
104c screw
108 handle
108a hanging hole portion
110 cam unit (conversion unit)
112 end cam
114 follower
115 fixing pin
116, 117 spindle
116a spring
117a positioning hole
118 adjustment unit
119 plunger
120 one-way clutch
120a outer ring
120b inner ring
122 outer ring fixing unit
122a housing
122b rotation stopper
122c rotation stopper pin
122d spring
122e eyenut
122f lid plate
124 handle restriction unit
124a latch
124aa slope portion
124b spring
124c restriction pin
126 spring
200 panel clamp
201 main body
202 hanging portion
203 receptor arm
204 fastening arm
205 ratchet wrench
S gripping space

1. A lifting clamp for gripping and lifting an object to be transported, the lifting clamp comprising:
a main body that includes a pair of opposite pieces opposed to form a gripping space where a portion to be gripped of the object to be transported can be accommodated;
a spindle that is attached to at least either one of the opposite pieces to rotate around a gripping direction as an axis and supports a lifting handle outside the main body;
a contact unit that is supported by the spindle on a gripping space side and contacts the object to be transport fdfdted i4 a gripping state; and
a conversion unit that is disposed around the spindle and converts rotational force of the spindle into pressing force of the contact unit onto the object to be transported.

2. The lifting clamp according to claim 1, wherein the conversion unit includes:
an end cam that is formed to surround the spindle and fixed to the opposite piece; and
a follower that is integrally rotatable with the spindle and slides over the end cam to cause a movement in the gripping direction.

3. The lifting clamp according to claim 1, wherein the conversion unit includes:
a cylindrical cam that is formed to surround the spindle and fixed to the opposite piece; and
a follower that is integrally rotatable with the spindle and slides over the cylindrical cam to cause a movement in the gripping direction.

4. The lifting clamp according to claim 1, wherein at least either one of the opposite pieces is equipped with an adjustment unit that adjusts a distance to the contact unit.

5. The lifting clamp according to claim 1, wherein the handle has at least one depressed portion outward in a radial direction of turning.

6. The lifting clamp according to claim 1, comprising a one-way clutch that includes an inner ring integrally movably attached to the spindle and an outer ring attached to the main body in a selectively fixable and releasable manner, and allows rotation of the spindle only in a direction of increasing the pressing force.

7. The lifting clamp according to claim 6, comprising an outer ring fixing unit that is provided between the outer ring and the main body and capable of fixing and releasing the outer ring to/from the main body.

8. The lifting clamp according to claim 7, wherein the spindle is fitted to the inner ring by transition fit.

9. The lifting clamp according to claim 8, comprising a handle restriction unit that restricts a turning range of the handle to be within a predetermined range.

10. The lifting clamp according to claim 9, wherein the handle restriction unit can accommodate the handle only in a direction of reducing the pressing force.
